(19) United States
(12) Patent Application Publication
(10) Pub. No.: US 2016/0105526 A1
(43) Pub. Date: Apr. 14, 2016

(54) Photographic Album Creation and Sharing

(71) Applicant: International Business Machines Corporation, Armonk, NY (US)

(72) Inventors: Barry A. Kritt, Atlantic Beach, NC (US); Sarbajit K. Rakshit, Kolkata (IN)

(73) Assignee: INTERNATIONAL BUSINESS MACHINES CORPORATION, Armonk, NY (US)

(21) Appl. No.: 14/512,920

(22) Filed: Oct. 13, 2014

(51) Int. Cl. H04L 29/08

(52) U.S. Cl. CPC H04L 67/306; H04L 67/22; H04L 67/06

(57) ABSTRACT

Embodiments of the invention relate to file sharing, and more specifically to sharing image files based on a spatiotemporal relationship. A device with image taking capabilities, such as a camera or mobile computing device, is provided with functionality to communicate with a shared pool of resources via a network connection. The device is connected to a network at a venue. As image files are captured in the venue, social contact metadata from all connected devices is embedded with the captured file(s). These files are published to a shared storage, and the publication includes the social contact metadata. Other image files from other devices may be added to the shared storage, with each added file having embedded social contact metadata. Authority to access the image files located on the shared storage is granted to social networking users based on their social networking name being contained within the embedded social contact metadata.

### BACKGROUND

### Field of the Invention

This invention relates to sharing of image files among event attendees. More specifically, the invention relates to limiting the image file sharing of event related images without requiring sharing of image files or information unrelated to the event.

With the advent and growth of social media together with electronic image files, there is an increased usage of image file transmission and sharing across a network connection. Image files may be directly communicated and shared using various methods, including, but not limited to use of electronic mail, use of social networking platforms, and accessing images from a shared location. In each of these alternatives, image files are uploaded to an associated location where the file may be viewed by friends, family, or associates who have been granted access to the file. With electronic mail, the file is uploaded and directly communicated to the recipient. Use of social networking is indirect in that the image file is placed in the associated storage, and the recipient has to access the storage to view or download the image file. A shared location allows image files to be uploaded and stored, and invitees to the shared location may view or otherwise access the image files.

Each of the mechanisms employed for sharing or otherwise accessing image files requires a known relationship between entities, the sender and the recipient in the case of electronic mail, a friendship in the case of social networking, and an exchange of electronic mail addresses in the case of a shared folder. In one embodiment, a friendship may be established and addresses may be exchanged or otherwise shared for the purpose of accessing image files. However, there is a required level of communication between the sender and the recipient that is established in order to promote the image sharing. Accordingly, various tools are available that allow image files to be electronically stored and accessed, with the access limited to entities that have established a relationship or access authorization.

### SUMMARY

The invention includes a method, computer program product, and system for automating creation and collaboration of image files based on a temporal relationship.

A method, computer program product, and system are provided to facilitate file sharing, and in one embodiment with the sharing based on a spatiotemporal relationship. A device is provided with image capturing functionality, and at the same time the device is provided with connectivity to a network when present at a defined venue. One or more images are captured by the device in the vicinity of the venue. Social media contact metadata of all venue participants is embedded with the captured file(s). The captured file(s) are published to a shared file storage area. The publication includes the embedded social contact metadata. An image file is selectively added to the shared file storage area, with each added file having the embedded social contact metadata of all venue participants.

Other features and advantages of this invention will become apparent from the following detailed description of the presently preferred embodiment(s) of the invention, taken in conjunction with the accompanying drawings.

### BRIEF DESCRIPTION OF THE SEVERAL VIEWS OF THE DRAWINGS

The drawings reference herein form a part of the specification. Features shown in the drawings are meant as illustrative of only some embodiments of the invention, and not of all embodiments of the invention unless otherwise explicitly indicated.

FIG. 1 depicts a block diagram illustrating a system that supports establishment of a spatiotemporal relationship and exchange of data or image files based on the relationship.

FIG. 2 depicts a flow chart illustrating a process for obtaining encrypted social network contact information, and adding that information to a device.

FIG. 3 depicts a flow chart illustrating a process for acquiring images from a network connected camera device, and embedding encrypted social network contact information of all other proximate network connected camera devices.

FIG. 4 depicts a flow chart illustrating a process for sharing image files during or after an event.

FIG. 5 depicts a block diagram of a computer system/server in a cloud computing node in the form of a general-purpose computing device.

FIG. 6 depicts a block diagram of a cloud computing environment.

FIG. 7 depicts a block diagram of a set of functional abstraction layers provided by the cloud computing environment.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

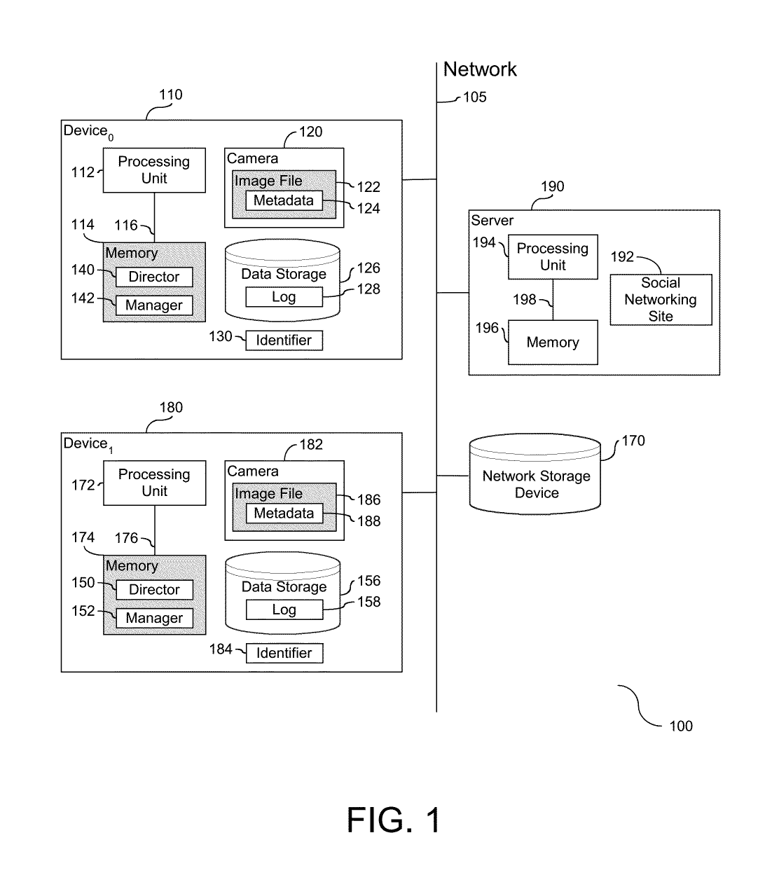

As demonstrated herein, a collaborative environment is created for sharing data or image files between users that have a spatiotemporal relationship. Relationships are established and maintained in a transitory manner, and generally for the purpose of sharing data for a defined venue or event. The relationship(s) may remain following the data sharing or data exchange, or the relationship may conclude. There is no requirement that the relationship be extended beyond the proposed data sharing or exchange. With reference to FIG. 1 a block diagram (100) is provided illustrating a system that supports establishment of a spatiotemporal relationship and exchange of data or image files based on the relationship. As shown, the system (100) is provided with a device (110) that has computing and data acquiring functionality. As shown herein, the device (110) is provided with a processing unit (112) in communication with memory (114) across a bus (116). The device (110) further includes a camera (120) to capture and acquire an image (122). The device (110) includes data storage (126) to store any captured images (122), also referred to as photographic image(s). In addition, the device (110) is provided with a network connection (105), to enable the device to communicate with a local or wide area network. Accordingly, the system shown herein includes a device that has image capabilities together with network connectivity.

The network connection (105) enables the device (110) to connect to a local or wide area network, and specifically, to send image or data files to a location accessible via the network. The device (110) includes an identifier (130) associated therewith. In one embodiment, the identifier (130) is an encrypted social networking contact identifier, such as a user name. Identifiers will also be referred to as social network contact information, social network contact identifiers, or social networking account identifiers.

The device (110) also includes tools to support the establishment of spatiotemporal relationships that enables file and data sharing with support of the network connection. The tools include a director (140) and a manager (142). The director (140) functions to manage social networking account identifiers for devices. More specifically, when the device is present at a defined location, and/or for a defined event, the director (140) obtains one or more encrypted social networking account identifiers associated with the user of the device. In one embodiment, the social networking account identifiers (130) were previously established with separate social network providers, and the director (140) functions to both obtain the encrypted version of the social network account information and to add the encrypted information to a profile of the device (110). Accordingly, the director (140) associates encrypted social network account identifiers (130) with the device (110).

As shown herein, a manager (142) is provided in communication with the director (140). The manager (142) functions to enable sharing data associated with or acquired by the device (110). More specifically, the manager (142) facilitates establishing a connection of the device (110) to a local or wide area network. In addition, the manager (142) authorizes sharing of encrypted social media contact information with other devices that are connected to the network (105). In one embodiment, the connection of other devices may be concurrent with connection of the device (110), but is not limited to the concurrent connection. Based on the authorization to share the encrypted social media contact information, the manager (142) shares or exchanges social media contact information of device (110) with all detected devices. In one embodiment, each device (110) has a separate director and manager, with each manager maintaining a local log (128), (158) of shared encrypted social media contact information.

The device (110) acquires data, which in one embodiment may be in the form of capturing an image and storing the image in an electronic image file (122). For each captured and stored image file (122), the manager (142) attaches or otherwise adds metadata to the file (122). It is understood that a user associated with the device (110) may choose to upload the image file (122) to a social networking site where an account was previously or is concurrently established, or to an alternative image sharing site.

As further shown, a server (190) is in communication with the device (110) across the network (105). The server (190) is configured with a processing unit (194) in communication with memory (196) across a bus (198). In one embodiment, the server (190) hosts one or more social networking sites (192). Following receipt of the image file (122), the social networking site (192) reads the image file metadata (124) and decrypts the social media contact information from the image file. At the same time, the social networking site (192) provides access to the image file (122) to each registered account holder that is identified in the decrypted metadata. The images files received by the social networking site are indirectly shared with registered account holders based on encrypted social networking identifiers embedded in the image file. Accordingly, sharing of the image files is based on a temporary presence in a venue and does not require direct exchange of information between the devices, and it also does not require that the registered account holders have an established social connection.

In addition to embedding metadata (124) with the created image (122), the manager (142) stores and/or publishes the created image (122). The device (110) includes memory (114) and/or data storage (126), either of which may be employed to store image files. Similarly, in one embodiment, the device (110) may include a portable storage device (not shown), such as a flash drive or an equivalent thereof, to store the image files. The image files may be copied from the camera (110) to a network storage device (170) across the network connection (105). The network storage device (170) may be any storage device that is in communication with the network connection (105). In one embodiment, the storage device (170) may be in the form of a shared storage device accessible via cloud computing storage, social networking, etc. Publication of the image (122) across the network (105) to the storage device (170) may be automated by the manager (142) as part of the image creation or it may take place manually following creation of the image.

In addition to publication of images to a shared location, such as data storage accessible by third parties across the network connection or a social networking site, the manager (142) functions to acquire social networking account identifiers from secondary devices. More than one device may have been present in the venue and acquired images. As shown herein, a second device (180) with the embedded functionality of the device (110) is present in the venue and includes a camera (182), to create images. The device (180) includes data storage (156) to store any captured images (186), also referred to as photographic image(s). The second device, device₁, (180) is present within the venue. Similar to device₀ (110), the second device, device₁, (180) is configured with a processing unit (172) in communication with memory (174) across a bus (176). The second device (180) is also includes tools to support the establishment of spatiotemporal relationships that enables file and data sharing with support of the network connection. The tools include a director (150) and a manager (152), with similar functionality to the director (140) and manager (142) of device₀ (110). The device (180) includes an identifier (184) associated therewith, with similar functionality to identifier (130) of device (110).

Each image (186) acquired by the camera (182) includes metadata (188) associated with the device (180) as well as device (110), and any other devices present within the venue. In one embodiment, the social networking contact information is encrypted. To maintain anonymity of the participants, the social networking identifier decryption takes place at the social networking provider. In one embodiment, the social networking provider maintains control of the private key required to decrypt the identifier. Once identified, the manager (142) may solicit social network contact information from the second device (180) or any other device with a designated sharing permission and social media contact information embedded in the file metadata. The relationship for sharing is established by the embedded metadata within the individual image files. In one embodiment, the relationship among images may be based upon a location, e.g. venue, or a time interval. Similarly, in another embodiment, the relationship among images may be based on a text-based tag applied to the image to define an event, i.e. event location and event time. Accordingly, the embedded metadata includes identifying information to solicit and/or acquire copies of images taken from one or more secondary devices based upon a common venue and/or time interval.

The tools shown herein embedded within the device (110) employ the processing unit (112) and memory (114) to support file sharing. The tools (140) and (142) are shown residing in memory (114) of the device (110), and tools (150) and (152) are shown residing in memory (174) of the device (180). In one embodiment, the tools (140) and (142), and (150) and (152), hereinafter referred to collectively as tools, may be implemented as a combination of hardware and software, and in communication with a shared pool of resources. Similarly, in one embodiment, the tools may be combined into a single functional item that incorporates the functionality of the separate items. For example, the tools may be embodied as an application in communication with the processing unit (112) and memory (114). As shown herein, each of the tools are shown local to the device (110). However, in one embodiment, they may be collectively or individually distributed across a shared pool of configurable computer resources and function as a unit to support file sharing based upon spatiotemporal relationships. Accordingly, the tools may be implemented as software tools, hardware tools, or a combination of software and hardware tools.

The described features, structures, or characteristics may be combined in any suitable manner in one or more embodiments. Examples of the managers have been provided to lend a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The tools shown and described in FIG. 1 may be implemented in programmable hardware devices such as field programmable gate arrays, programmable array logic, programmable logic devices, or the like. The tool(s) may also be implemented in software for processing by various types of processors. An identified tool of executable code may, for instance, comprise one or more physical or logical blocks of computer instructions which may, for instance, be organized as an object, procedure, function, or other construct. Nevertheless, the executable of an identified tool need not be physically located together, but may comprise disparate instructions stored in different locations which, when joined logically together, comprise the tools and achieve the stated purpose of the tools.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

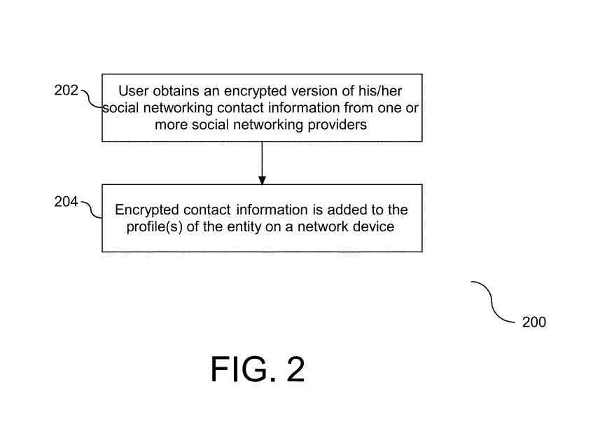

As shown in FIG. 1, a shared folder of data or image files is created based upon venue and presence at the venue without employing location data tracking, such as global positioning data. With reference to FIG. 2, a flow chart (200) is provided illustrating a process for obtaining encrypted social network contact information, and adding that information to a device. A precursor to the file sharing environment is the entity using the functionality obtains an encrypted version of their social networking contact information from one or more social networking providers (202). In one embodiment, the entity may have two or more social networking accounts, each with different social networking providers, or in one embodiment, with the same networking provider. This encrypted contact information is added to the profiles of the entity on a network device (204). For example, the entity may be a user, with the encrypted social networking contact information added to their profile on a smart phone with an embedded camera, or any network connected camera. Similarly, in one embodiment, there may be multiple camera users for a single camera, with each user having their profile embedded in the camera. At the same time, a one or more users may have more than one encrypted social media contact information. Accordingly, the process shown in FIG. 2 addresses obtaining and storing user profile information containing encrypted contact information.

With the advent of social networking, people are virtually connected for social growth and/or business development. Most social networking venues require connections or relationships to be established prior to sharing data. The encrypted contact information introduced in FIG. 2 may be employed for sharing data without an established social connection, or without the conventional tools to establish the social connection. Rather, the data sharing is limited, e.g. temporary, and based upon the users being at the same venue at the same time, defined by their encrypted social networking contact information being within the image file metadata, or an equivalent thereof.

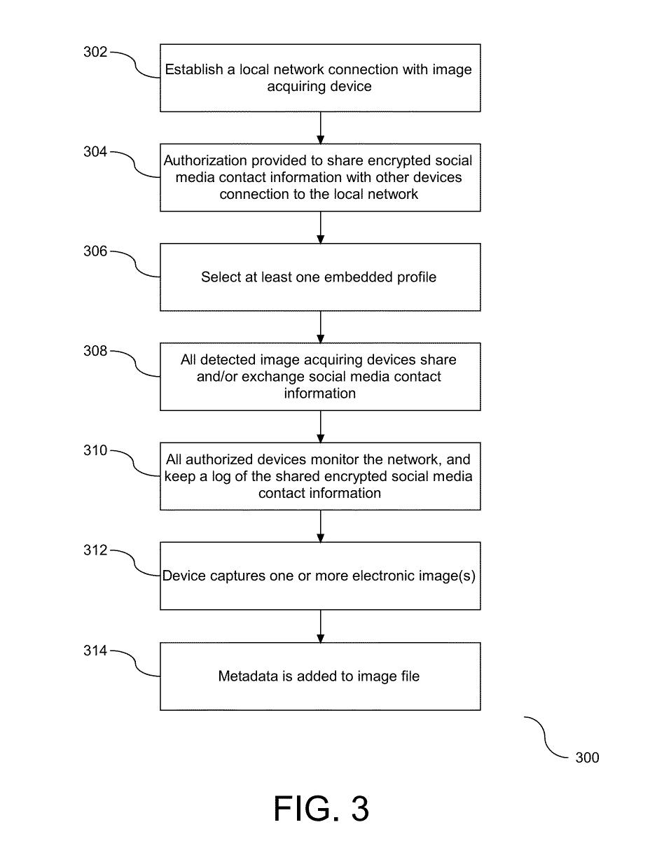

Referring to FIG. 3, a flow chart (300) is provided illustrating a process for acquiring images from a network connected camera device, and embedding encrypted social network contact information of all proximate network connected camera devices. As shown, a local network connection is established by an image acquiring device at a venue (302), as shown and described in FIG. 1. Authorization is provided to share encrypted social media contact information embedded with the image acquiring device with other devices that have established or will establish connection to the local network (304). As shown in FIG. 1, the image acquiring device may have more than one embedded or registered social media profile. As such, one of the profiles embedded in the device is selected (306). The selection at step (306) determines which encrypted social profile will be shared. Following the selection at step (306), all image acquiring devices detected within the local network connection share and/or exchange their social media contact information (308). As devices may enter and leave the network at different times, all of the devices that have received authorization monitor the network connection and maintain a log of the encrypted social media contact information shared by all of the detected devices in the network (310). In one embodiment, this log may be used to establish an event based limited friendship on one or more social networking venues. As an image is captured by one of the detected devices (312), metadata is added to an associated image file (314), with the metadata including a full set of encrypted social media contact information obtained for all of the network detected devices. In one embodiment, the metadata also includes information on the time the image was acquired, and optionally geotag information. Similarly, in one embodiment, the entity acquiring the image file can request that the device capture and store the metadata without requiring it to be associated with an electronic image file. Accordingly, the image acquiring device captures one or more image file and embeds social media contact information for devices detected within the network, the information embedded as metadata of the acquired image.

It is understood that the image capturing device(s) are mobile or otherwise portable. The attraction at a venue, as well as the audience, changes over time. Accordingly, in one embodiment, time associated with the capture of the image is embedded in the image file as part of the image file metadata.

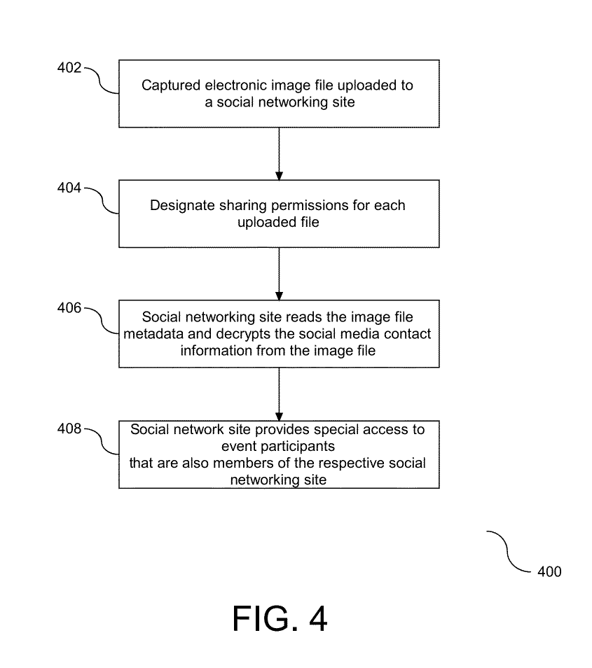

It is understood that the acquired image files are electronic files that may be downloaded to a storage device, and/or shared on a social networking site. Referring to FIG. 4, a flow chart (400) is provided illustrating a process for sharing image files during or after an event. As shown in FIG. 4, access to image files can be provided based on a spatiotemporal relationship. After an electronic image file has been captured, the file is uploaded to a social networking site (402). In one embodiment, the file with the associated metadata may be uploaded to the site without the image. On an individual basis, restrictions or sharing privileges may be assigned to the uploaded files. Specifically, sharing permissions for each uploaded file are designated (404). In one embodiment, the permission may extend beyond established friendships to attendees at a shared venue. More specially, the sharing permissions include those that had cameras or equivalent devices at an event and shared their encrypted social media contact information. Following step (404), the social networking site reads the image file metadata and decrypts the social media contact information from the image file (406). The decryption of the contact information identifies all social networking participants at an event so that the participants may be included in an event based limited friendship. There is a plurality of social networking sites, and each site is only able to decrypt the encrypted social media contact information that is associated with the respective site. Following step (406), the social network site provides special access, or in one embodiment, limited access to event participants that are also members of the respective social networking site (408). The friendship at step (408) is limited to participants of an event who had at least one detected image capturing device with an embedded and encrypted social media contact identifier. In one embodiment, the access provided may be further limited to sharing image files taken within a limited time range. Similarly, in one embodiment, the access provided may be further limited to image files within a specified or identified geotag range. Accordingly, limited access to image files is provided in conjunction with one or more social networking to one or more devices detected within a venue.

The image sharing capabilities shown and described herein is based on network connectivity and/or embedded metadata. There is no person-to-person communication required. The communication for image sharing is based upon metadata, e.g. the owners of the devices do not need to establish a direct relationship through social networking or a shared pool of resources.

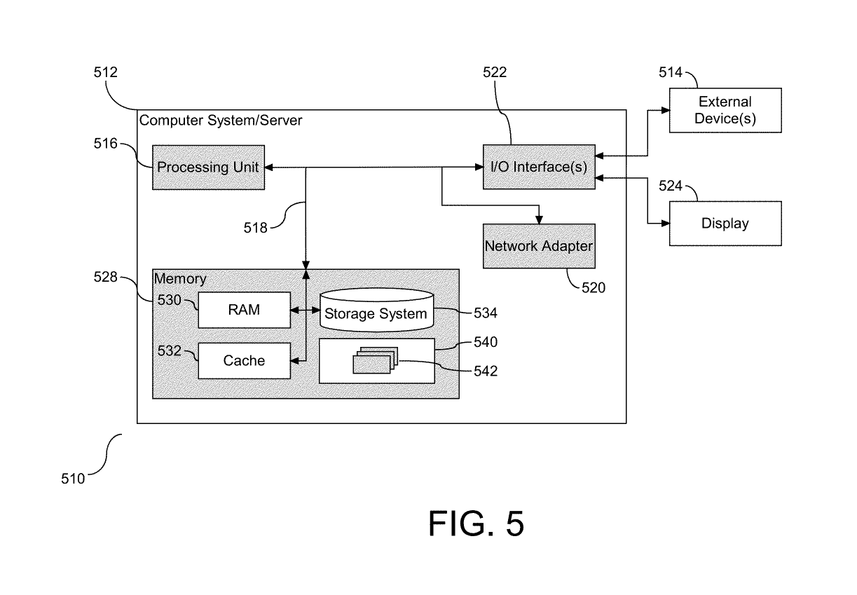

As described in reference to FIGS. 1-4, the device and the associated file sharing functionality may be employed in a shared pool of configurable resources, e.g. a cloud based system. A cloud computing environment is service oriented with a focus on statelessness, low coupling, modularity, and semantic interoperability. At the heart of cloud computing is an infrastructure comprising a network of interconnected nodes. Referring now to FIG. 5, a schematic of an example of a cloud computing node is shown. Cloud computing node (510) is only one example of a suitable cloud computing node and is not intended to suggest any limitation as to the scope of use or functionality of embodiments of the invention described herein. Regardless, cloud computing node (510) is capable of being implemented and/or performing any of the functionality set forth hereinabove. In cloud computing node (510) there is a computer system/server (512), which is operational with numerous other general purpose or special purpose computing system environments or configurations. Examples of well-known computing systems, environments, and/or configurations that may be suitable for use with computer system/server (512) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that includes any of the above systems or devices, and the like.

Computer system/server (512) may be described in the general context of computer system-executable instructions, such as program modules, being executed by a computer system. Generally, program modules may include routines, programs, objects, components, logic, data structures, and so on that perform particular tasks or implement particular abstract data types. Computer system/server (512) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server (512) in cloud computing node (510) is shown in the form of a general-purpose computing device. The components of computer system/server (512) may include, but are not limited to, one or more processors or processing units (516), a system memory (528), and a bus (518) that couples various system components including system memory (528) to processor (516). Bus (518) represents one or more of any of several types of bus structures, including a memory bus or memory controller, a peripheral bus, an accelerated graphics port, and a processor or local bus using any of a variety of bus architectures. By way of example, and not limitation, such architectures include an Industry Standard Architecture (ISA) bus, a Micro Channel Architecture (MCA) bus, an Enhanced ISA (EISA) bus, Video Electronics Standards Association (VESA) local bus, and a Peripheral Component Interconnects (PCI) bus. A computer system/server (512) typically includes a variety of computer system readable media. Such media may be any available media that is accessible by a computer system/server (512), and it includes both volatile and nonvolatile media, and removable and non-removable media.

System memory (528) can include computer system readable media in the form of volatile memory, such as random access memory (RAM) (530) and/or cache memory (532). Computer system/server (512) may further include other removable/nonremovable, volatile/non-volatile computer system storage media. By way of example only, storage system (534) can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (518) by one or more data media interfaces. As will be further depicted and described below, memory (528) may include at least one program product having a set (e.g., at least one) of program modules that are configured to carry out the functions of embodiments of the invention.

Program/utility (540), having a set (at least one) of program modules (542), may be stored in memory (528) by way of example, and not limitation, as well as an operating system, one or more application programs, other program modules, and program data. Each of the operating systems, one or more application programs, other program modules, and program data or some combination thereof, may include an implementation of a networking environment. Program modules (542) generally carry out the functions and/or methodologies of embodiments of the invention as described herein.

Computer system/server (512) may also communicate with one or more external devices (514), such as a keyboard, a pointing device, a display (524), etc.; one or more devices that enable a user to interact with computer system/server (512); and/or any devices (e.g., network card, modem, etc.) that enable computer system/server (512) to communicate with one or more other computing devices. Such communication can occur via Input/Output (I/O) interfaces (522). Still yet, computer system/server (512) can communicate with one or more networks such as a local area network (LAN), a general wide area network (WAN), and/or a public network (e.g., the Internet) via network adapter (520). As depicted, network adapter (520) communicates with the other components of computer system/server (512) via bus (518). It should be understood that although not shown, other hardware and/or software components could be used in conjunction with computer system/server (512). Examples, include, but are not limited to: microcode, device drivers, redundant processing units, external disk drive arrays, RAID systems, tape drives, and data archival storage systems, etc.

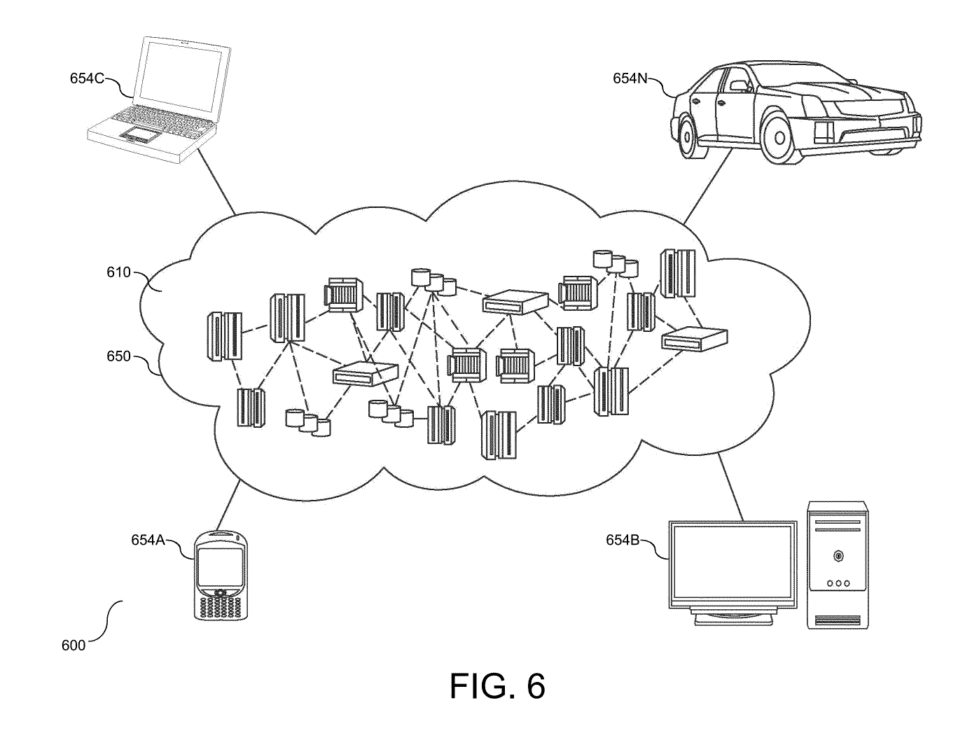

Referring now to FIG. 6, illustrative cloud computing environment (650) is depicted. As shown, cloud computing environment (650) comprises one or more cloud computing nodes (610) with which local computing devices used by cloud consumers, such as, personal digital assistant (PDA) or cellular telephone (654A), desktop computer (654B), laptop computer (654C), and/or automobile computer system (654N) may communicate. Nodes (610) may communicate with one another. They may be grouped (not shown) physically or virtually, in one or more networks, such as Private, Community, Public, or Hybrid clouds as described hereinabove, or a combination thereof. This allows cloud computing environment (650) to offer infrastructure, platforms and/or software as services for which a cloud consumer does not need to maintain resources on a local computing device. It is understood that the types of computing devices (654A)-(654N) shown in FIG. 6 are intended to be illustrative only and that computing nodes (610) and cloud computing environment (650) can communicate with any type of computerized device over any type of network and/or network addressable connection (e.g., using a web browser).

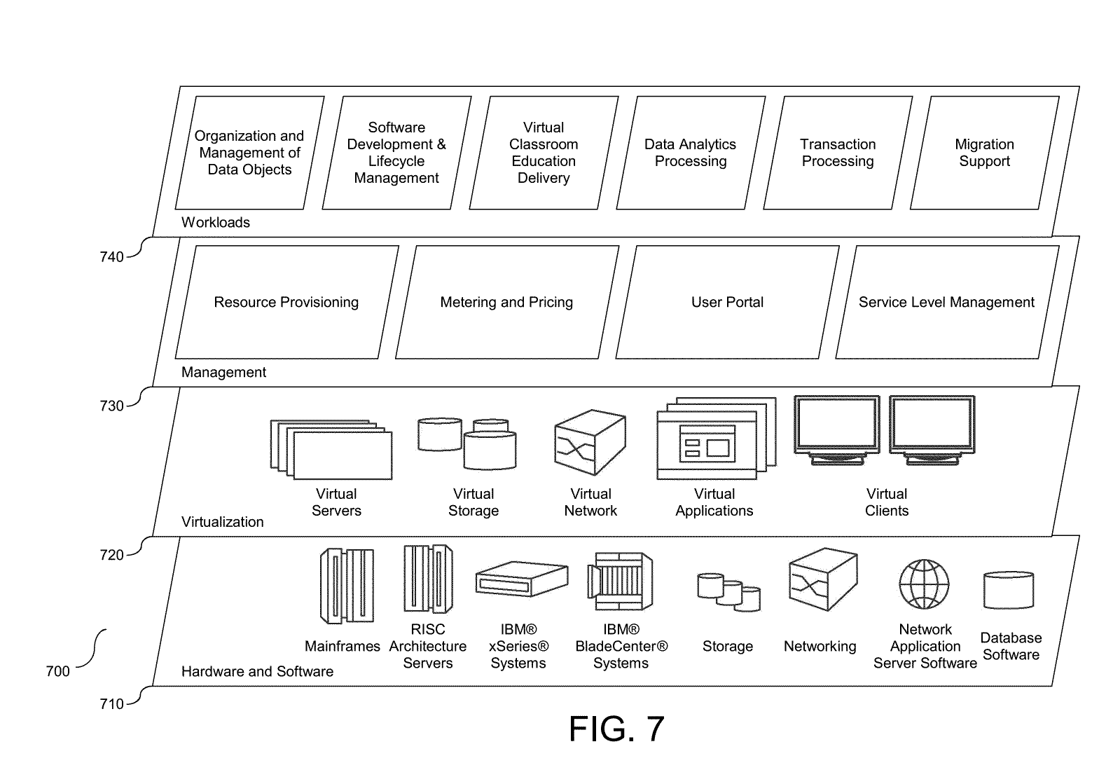

Referring now to FIG. 7, a set of functional abstraction layers provided by cloud computing environment (650) is shown. It should be understood in advance that the components, layers, and functions shown in FIG. 7 are intended to be illustrative only and embodiments of the invention are not limited thereto. As depicted, the following layers and corresponding functions are provided: hardware and software layer (710), virtualization layer (720), management layer (730), and workload layer (740). The hardware and software layer (710) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (720) provides an abstraction layer from which the following examples of virtual entities may be provided: virtual servers; virtual storage; virtual networks, including virtual private networks; virtual applications and operating systems; and virtual clients.

In one example, management layer (730) may provide the following functions: resource provisioning, metering and pricing, user portal, and service level management. The functions are described below. Resource provisioning provides dynamic procurement of computing resources and other resources that are utilized to perform tasks within the cloud computing environment. Metering and pricing provides cost tracking as resources that are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer (740) provides examples of functionality for which the cloud computing environment may be utilized. In the shared pool of configurable computer resources described herein, hereinafter referred to as a cloud computing environment, files may be shared among users within multiple data centers, also referred to herein as data sites. An example of workloads and functions which may be provided from this layer includes, but is not limited to, organization and management of data objects within the cloud computing environment and file sharing based on spatiotemporal relationships. In the shared pool of configurable computer resources described herein, hereinafter referred to as a cloud computing environment, files may be shared among users within multiple data centers, also referred to herein as data sites. A series of mechanisms are provided within the shared pool to provide organization and management of data storage. Accordingly, a series of mechanisms are provided within the shared pool to support organization and management of data storage within the cloud computing environment.

The device described above in FIG. 1, and further elaborated on in FIG. 4, has been labeled with tools in the form of a director and a manager, hereinafter referred to as tools. The tools may be implemented in programmable hardware devices such as field programmable gate arrays, programmable array logic, programmable logic devices, or the like. The tools may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the tools need not be physically located together, but may comprise disparate instructions stored in different locations which, when joined logically together, comprise the tools and achieve the stated purpose of the tool.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, the implementation of the device detection and image acquisition, including embedding of metadata within the image file(s), is directed to sharing of image files in a shared pool of configurable resources based on a spatiotemporal relationship.

It will be appreciated that, although specific embodiments of the invention have been described herein for purposes of illustration, various modifications may be made without departing from the spirit and scope of the invention. For example, image files may be shared through a manual process wherein a user adds a text tag indicating an event name as an identifier. This or other manual processes do not rely on sharing encrypted social networking contact information using a network. Accordingly, the scope of protection of this invention is limited only by the following claims and their equivalents.

We claim:

1. A method comprising:
connecting a device with image capturing capabilities to a network at a defined venue;
the device capturing one or more image files in a vicinity of the venue;
embedding social media contact metadata of all venue participants associated with participating devices within the one or more captured image files;
publishing at least one captured file to a shared storage area, the publication including the embedded social media contact metadata; and
selectively adding an image file to the shared storage area, wherein the added file includes embedded social network contact metadata associated with the participants associated with venue participating devices.

2. The method of claim 1, further comprising adding an additional image file to the shared storage area, including searching a social networking site for the additional image file, wherein the additional file includes the social network contact.

3. The method of claim 2, wherein activation of the search is limited to a time interval for the venue.

4. The method of claim 2, further comprising encrypting the social contact metadata embedded in the image file.

5. The method of claim 1, further comprising sharing the files in the shared storage area with social network users that were identified in the embedded social network contact information metadata.

6. A computer program product for facilitating file sharing, the computer program product comprising a computer readable storage device having program code embodied therewith, the program code executable by a processor to:
connect a device with image capturing capabilities to a network at a defined venue;
the device capturing one or more image files in a vicinity of the venue;
embed social media contact metadata of all venue participants associated with the participating devices with the one or more captured image files;
publish at least one captured file to a shared storage area, the publication including the embedded social media contact metadata; and
selectively add an image file to the shared storage, wherein the added file includes embedded social contact metadata associated with the participants associated with venue participating devices.

7. The computer program product of claim 6, further comprising program code to add an additional image file to the shared storage area, including searching a social networking site for the additional image file, wherein the additional file includes the social network contact.

8. The computer program product of claim 7, wherein activation of the search is limited to a time interval for the venue.

9. The computer program product of claim 7, further comprising program code to encrypt the social contact metadata embedded in the image file.

10. The computer program product of claim 6, further comprising program code to share the files in the shared storage area with each social network uses that were identified in the embedded social network contact information metadata.

11. A system comprising:
a device having functionality to capture an image and to embed the image within an electronic file, the device having a network connection;
the device to capture one or more image files in a vicinity of a defined venue;
a manager to embed social media contact metadata of all venue participants associated with participating devices within the one or more captured image files;
the manager to publish at least one captured image file to a shared storage area, the publication including the embedded social contact metadata; and
the manager to selectively add an image file to the shared storage, wherein each added file includes embedded social network contact metadata associated with the participants associated with venue participating devices.

12. The system of claim 11, further comprising the manager to add an additional image file to the shared storage, including a search of a social networking site for the additional image file, wherein the additional file includes the social network contact.

13. The system of claim 12, wherein activation of the search is limited to a time interval for the venue.

14. The system of claim 12, further comprising a director in communication with the manager, the director to encrypt the social contact metadata embedded in the image file.

15. The system of claim 11, further comprising the manager to share the files in the shared storage area with social network users that were identified in the embedded social network contact information metadata.
